(19) United States
(12) Patent Application Publication
(10) Pub. No.: US 2019/0004513 A1
(43) Pub. Date: Jan. 3, 2019

(54) DRIVING ASSISTANCE CONTROL APPARATUS

(71) Applicant: DENSO CORPORATION, Kariya-city ,Aichi-pref (JP)

(72) Inventors: Kunihiko CHIBA, Kariya-city, Aichi-pref. (JP); Hisashi IIDA, Kariya-city, Aichi-pref. (JP); Minoru OKADA, Kariya-city, Aichi-pref. (JP)

(21) Appl. No.: 15/748,597

(22) PCT Filed: Jul. 11, 2016
(86) PCT No.: PCT/JP2016/070403

§ 371 Date: Jan. 29, 2018

(30) Foreign Application Priority Data
Jul. 31, 2015 (JP) 2015-152015

(51) Int. Cl. G05D 1/00; B60W 30/09; B60W 30/095; B60W 50/14; B60W 50/08

(52) U.S. Cl. CPC G05D 1/0061; B60W 30/09; B60W 30/0956; B60W 2050/143; B60W 50/082; G05D 1/0088; G05D 2201/0213; B60W 50/14

(57) ABSTRACT

A control unit performs driving assistance. An acquiring unit acquires future circumstance information related to a future circumstance that an own vehicle is predicted to subsequently encounter on a route further ahead of a current location. A determining unit determines whether or not the future circumstance indicated by the acquired future circumstance information is applicable to an event in which continuation of driving assistance is not possible. An urgency level setting unit sets an urgency level that indicates a level of urgency of the future circumstance when the determining unit determines that continuation of driving assistance is not possible. A limit setting unit sets a limit related to time or distance at which to cancel driving assistance and switch to manual driving, based on the set urgency level. A notifying unit notifies a driver of information prompting cancellation of driving assistance based on content of the set limit.

### CROSS-REFERENCE TO RELATED APPLICATIONS

The present application is based on and claims the benefit of priority from Japanese Patent Application No. 2015-152015, filed on Jul. 31, 2015, the descriptions of which are incorporated herein by reference.

### TECHNICAL FIELD

The present disclosure relates to a driving assistance control apparatus that automatically performs a driving operation related to traveling of a vehicle.

### BACKGROUND ART

Conventionally, a technology related to driving assistance in which a driving operation related to traveling of a vehicle is automatically performed in place of a driver is known. For example, PTL 1 describes a technology in which whether or not automatic driving is possible is determined based on peripheral conditions and the like of an own vehicle. When automatic driving is determined to not be possible, a notification that prompts cancellation of automatic driving is given to the driver.

### CITATION LIST

### Patent Literature

[PTL 1] JP-A-2014-106854

### SUMMARY OF INVENTION

### Technical Problem

The above-described conventional technology is such that an environment in which the own vehicle is currently placed is recognized as peripheral conditions. After continuation of automatic driving is determined to not be possible based on the peripheral conditions, the driver is notified of the cancellation of automatic driving. However, when the driver is notified of the cancellation of automatic driving upon encountering a circumstance in which continuation of automatic driving is not possible, as a result of time being required until automatic driving is switched to manual driving, response to the circumstance may be delayed.

Therefore, for example, when automatic driving is predicted to not be possible in a future situation that the vehicle will subsequently encounter (such as several seconds later or several kilometers ahead), the notification being given at an earlier stage than a point in time at which the own vehicle encounters this circumstance is considered effective.

An object of the present disclosure is to provide a technology for giving effective notification to a driver based on a future circumstance that is predicted to make automatic driving (or also referred to as driving assistance) not possible.

### Solution to Problem

According to an aspect of the present disclosure, a driving assistance control apparatus that includes a control unit, an acquiring unit, a determining unit, an urgency level setting unit, a limit setting unit, and a notifying unit is provided. Reference numbers within the parentheses in the claims indicate corresponding relationships with specific means according to an embodiment described hereafter as an aspect, and do not limit the technical scope of the present disclosure.

The control unit performs driving assistance in which a portion or all of driving operations related to traveling of an own vehicle is automatically performed. The acquiring unit acquires future circumstance information related to a future circumstance that the own vehicle is predicted to subsequently encounter on a route further ahead of a current location. The determining unit determines whether or not the future circumstance indicated by the future circumstance information acquired by the acquiring unit is applicable to an event in which continuation of driving assistance is not possible. The urgency level setting unit sets an urgency level that indicates a level of urgency of the future circumstance when the determining unit determines that continuation of driving assistance is not possible. The limit setting unit sets a limit related to time or distance at which to cancel driving assistance and switch to manual driving, based on the urgency level set by the urgency level setting unit. The notifying unit notifies a driver of information prompting cancellation of driving assistance based on content of the limit set by the limit setting unit.

According to an aspect of the present disclosure, whether or not continuation of driving assistance is possible can be determined in advance, based on a future circumstance that the own vehicle is predicted to subsequently encounter. In addition, based on the urgency of the future circumstance in which continuation of driving assistance is determined to not be possible, a limit at which to cancel driving assistance and switch to manual driving can be set, and the driver can be notified. As a result, the driver can be notified at an earlier stage than a point in time at which the own vehicle encounters the circumstance in which continuation of driving assistance becomes not possible. The driver can make a response, such as canceling automatic driving and switching to manual driving, with leeway.

### BRIEF DESCRIPTION OF DRAWINGS

The above-described object, other objects, characteristics, and advantages of the present disclosure will be clarified through the detailed description below, with reference to the accompanying drawings. In the drawings:

FIG. 1 is a block diagram showing a configuration of a vehicle traveling control system according to an embodiment of the present disclosure;

FIG. 2 is an explanatory diagram showing an example of the content of an urgency level database; and

FIG. 3 is a flowchart showing steps in an automatic driving monitoring process by a traveling control unit in FIG. 1.

### DESCRIPTION OF EMBODIMENTS

An embodiment of the present disclosure will hereinafter be described with reference to the drawings. The present disclosure is not limited to the embodiment described below and may be carried out by various modes.

### [Description of a Configuration of a Vehicle Traveling Control System]

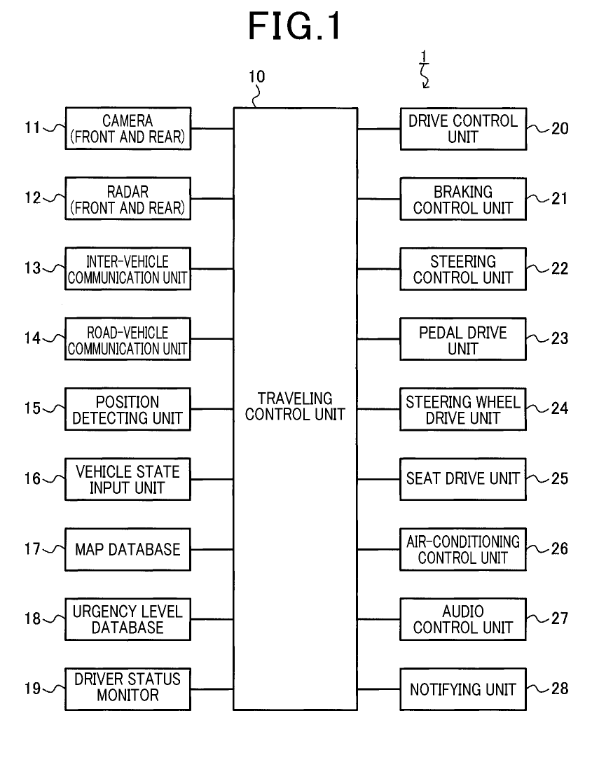

A configuration of a vehicle traveling control system 1 according to the present embodiment will be described with reference to FIG. 1. The vehicle traveling control system 1 is a system that controls automatic driving in which a driving operation, such as acceleration, steering, or braking, of an own vehicle is automatically performed, as an example of driving assistance in the present disclosure. As shown as an example in FIG. 1, the vehicle traveling control system 1 is configured by a traveling control unit 10 and units that are connected to the traveling control unit 10. Cameras (front and rear) 11, radars (front and rear) 12, an inter-vehicle communication unit 13, a road-vehicle communication unit 14, a position detecting unit 15, a vehicle state input unit 16, a map database 17, an urgency level database 18, a driver status monitor 19, a drive control unit 20, a braking control unit 21, a steering control unit 22, a pedal drive unit 23, a steering wheel drive unit 24, a seat drive unit 25, an air-conditioner control unit 26, an audio and video control unit 27, and a notifying unit 28 are connected to the traveling control unit 10.

The traveling control unit 10 is an information processing apparatus that is mainly configured by a central processing unit (CPU), a read-only memory (ROM), a random access memory (RAM), an input/output interface, and the like (none shown). The traveling control unit 10 controls an automatic driving function for making an own vehicle travel by automatically performing a driving operation, such as acceleration, braking, or steering, of the own vehicle. Automatic driving herein includes making the own vehicle travel to a designated destination in a completely automatic manner. In addition, for example, automatic driving also includes traveling to which driving assistance that carries out a portion of driving operations related to traveling of the own vehicle, such as a traffic lane deviation prevention assistance function (lane keeping assist system) and an inter-vehicle and traffic lane control function (adaptive cruise control), is applied. The traveling control unit 10 corresponds to a control unit, an acquiring unit, a determining unit, an urgency level setting unit, a limit setting unit, a notifying unit, and an emergency measure unit of a driving assistance control apparatus.

The traveling control unit 10 makes the own vehicle travel along a route to a destination while comparing a current location of the own vehicle and road map data. In addition, the traveling control unit 10 determines peripheral conditions through the cameras 11, the radars 12, the inter-vehicle communication unit 13, and the road-vehicle communication unit 14, and determines acceleration, braking, and steering operations required for safe traveling. The peripheral conditions include other traffic, such as peripheral vehicles, traffic lights, signs, road shape, and obstacles. Then, the traveling control unit 10 makes the own vehicle travel by operating various types of actuators of the drive control unit 20, the brake control unit 21, the steering control unit 22, and the like based on the determined operation. According to the present embodiment, as a function that is actualized by the traveling control unit 10, details of control in which whether or not continuation of automatic driving is possible is determined based on various types of information including a future circumstance that is predicted to be subsequently encountered on a route that is planned to be traveled, and a response based on the determination result is performed, will be described. Here, for example, the route that is planned to be traveled is a route to a destination that is set by a navigation system (not shown) mounted in the own vehicle, or an extension of a road on which the own vehicle is currently traveling.

The cameras 11 are imaging apparatuses that are respectively set in the front and rear of the vehicle. The cameras 11 capture images of a frontward area and a rearward area of the own vehicle, and output data of the captured images to the traveling control unit 10

The radars 12 are sensors that transmit radio waves or laser light towards respective detection-target areas ahead of and to the rear of the own vehicle, and detect whether or not a target is present and a distance to the target by receiving reflected waves of the radio waves or laser light. According to the present embodiment, use of the cameras 11 and the radars 12 as optical or electromagnetic sensors for recognizing other vehicles and obstacles present ahead of and to the rear of the own vehicle, the road shape, and the like is assumed.

The inter-vehicle communication unit 13 is a wireless communication apparatus that performs wireless communication (inter-vehicle communication) with a communication apparatus that is mounted in another vehicle. The traveling control unit 10 performs inter-vehicle communication with a peripheral vehicle that is present within a wireless communication-possible range of the inter-vehicle communication unit 13 and acquires various types of information provided by the peripheral vehicle. According to the present embodiment, an application in which a position and behavior, such as speed, acceleration, and advancing direction, of a peripheral vehicle are determined based on the information acquired from another vehicle by the inter-vehicle communication unit 13 is assumed. In addition, an application in which information indicating a distant environment state (such as temporary traffic restrictions accompanying construction or an accident, traffic jams, weather, or an approach of an emergency vehicle) acquired by another vehicle is acquired through inter-vehicle communication, and a future circumstance that the own vehicle is predicted to subsequently encounter on a route that is planned to be traveled is determined, is assumed. The information indicating these distant environment states includes information related to type of event, position, and time.

The road-vehicle communication unit 14 is a wireless communication apparatus for receiving information provided by an information provision apparatus (roadside apparatus) that is set on a road. According to the present embodiment, an application in which a position and behavior, such as speed, acceleration, and advancing direction, of each vehicle present in a peripheral monitoring-target area are detected by the roadside apparatus and vehicle detection information related to each vehicle is provided by wireless communication is assumed. The traveling control unit 10 determines the position and the behavior of each vehicle traveling in the periphery based on the vehicle detection information received from the roadside apparatus by the road-vehicle communication unit 14. In addition, an application in which information indicating a distant environment state (such as temporary traffic restrictions accompanying construction or an accident, traffic jams, weather, or an approach of an emergency vehicle) is acquired from the roadside apparatus through inter-vehicle communication, and a future circumstance that the own vehicle is predicted to subsequently encounter on a route that is planned to be traveled is determined, is assumed. The information indicating these distant environment states includes information related to type of event, position, and time.

The position detecting unit 15 detects the current location of the own vehicle based on detection results from a global positioning system (GPS) receiver, a gyro sensor, a vehicle speed sensor, or the like (none shown), and outputs the detected current location information to the traveling control unit 10.

The vehicle state input unit 16 inputs various types of information indicating a vehicle state to the traveling control unit 10. According to the present embodiment, as the information indicating the vehicle state, a measurement value from a sensor that measure behavior, such as speed, acceleration, or angular velocity, of the own vehicle, a state of a vehicle system (recognition and determination system, and traveling control system), an operating signal of a steering wheel operation, an accelerator operation, a brake operation, or the like by the driver, and the like are assumed.

The map database 17 is a storage apparatus that stores therein map data for route guidance. The map data includes various types of data, such as node data corresponding to a road node, link data corresponding to a road segment between nodes, attribute data corresponding to nodes and links, and facility data.

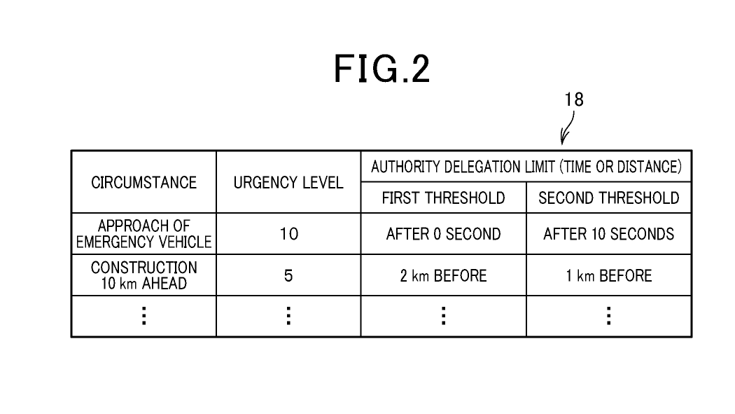

The urgency level database 18 is a database that stores therein information in which an urgency level indicating a level of urgency and an authority transfer limit are defined regarding a plurality of circumstances applicable to events in which continuation of automatic driving is not possible. As shown as an example in FIG. 2, the urgency level database 18 stores therein a table in which a circumstance in which continuation of automatic driving is not possible, and an urgency level and an authority transfer limit (first threshold and second threshold) corresponding to the circumstance are described in association. As circumstances in which continuation of automatic driving is not possible, road construction and accidents, temporary traffic restrictions, traffic jams, bad weather, the approach of an emergency vehicle, and the like are given as examples.

The urgency level is a value that indicates the level of urgency. The urgency level is information that is set so as to be a greater numeric value as delay in cancellation of automatic driving and switching to manual driving for the circumstance in which continuation of automatic driving is not possible decreases. The authority transfer limit is information that indicates a limit related to time or distance at which to perform a notification that prompts preparation for transfer of authority over driving to the driver, or emergency evacuation traveling, as a measure taken before continuation of automatic driving becomes not possible.

The authority transfer limit includes the first threshold and the second threshold. The first threshold is a value that indicates a limit on time or distance at which to warn the driver that automatic driving will be canceled and switched to manual driving. The second threshold is a value that indicates a limit on time or distance at which to perform emergency evacuation when the driver does not accept the cancellation of automatic driving after being warned based on the first threshold. Here, the authority transfer limit is set such that the first threshold is earlier and the second threshold is later, in order of time series. For example, the first threshold and the second threshold are set as values that indicate an elapse of time from a point in time at which the corresponding circumstance is determined or a distance from a location at which the corresponding circumstance occurs.

Returning to the description of the block diagram in FIG. 1, the driver status monitor 19 is configured by an in-cabin camera and sensors for observing a state of the driver. According to the present embodiment, for example, as the state of the driver to be observed by the driver status monitor 19, movement of eye gaze, state of wakefulness, posture, operating state of switches, and the like are assumed.

The drive control unit 20 is a control apparatus that includes an actuator that operates an accelerator and a transmission of the own vehicle. The traveling control unit 10 controls acceleration and deceleration of the own vehicle by sending a control command to the drive control unit 20 based on a traveling plan that is calculated based on the state of the own vehicle and its periphery.

The brake control unit 21 is a control apparatus that includes an actuator that operates the brake of the own vehicle. The traveling control unit 10 controls braking of the own vehicle by sending a control command to the brake control unit 21 based on the traveling plan that is calculated based on the state of the own vehicle and its periphery.

The steering control unit 22 is a control apparatus that includes an actuator that operates a steering apparatus of the own vehicle. The traveling control unit 10 controls steering of the own vehicle by sending a control command to the steering control unit 22 based on the traveling plan that is calculated based on the state of the own vehicle and its periphery.

The pedal drive unit 23 is an actuator that operates a brake pedal of the vehicle. According to the present embodiment, an application in which the traveling control unit 10 operates the brake via the pedal drive unit 23 to alert or perform a wake-up measure on the driver is assumed.

The steering wheel drive unit 24 is an actuator that presents tactile force and physical force information that works on the hands of the driver via the steering wheel of the own vehicle. According to the present embodiment, the traveling control unit 10 may provide the tactile force and physical force information to the driver via the steering wheel drive unit 24, to alert or perform a wake-up measure on the driver.

The seat drive unit 25 is an actuator that presents tactile force and physical force information that works on the body of the driver via the driver's seat of the own vehicle. According to the present embodiment, an application in which the traveling control unit 10 presents the tactile force and physical force information to the driver via the seat drive unit 25 to alert or perform a wake-up measure on the driver is assumed.

The air-conditioning control unit 26 is an electronic control apparatus that controls an air-conditioner of the own vehicle. According to the present embodiment, an application in which the traveling control unit 10 moderately controls the air-conditioner (such as by changes in temperature and air volume, or a change in scent) via the air-conditioning control unit 26 to alert or perform a wake-up measure on the driver is assumed.

The audio and video control unit 27 is an electronic control apparatus that controls audio and video equipment of the own vehicle. According to the present embodiment, an application in which the traveling control unit 10 performs output control of video and audio content via the audio and video control unit 27 to present information to or alert the driver is assumed.

The notifying unit 28 is an output apparatus for notifying the driver of various types of information. For example, the notifying unit 28 is actualized by a display apparatus that displays an image or an audio output apparatus that outputs audio information.

### [Description of an Automatic Driving Monitoring Process]

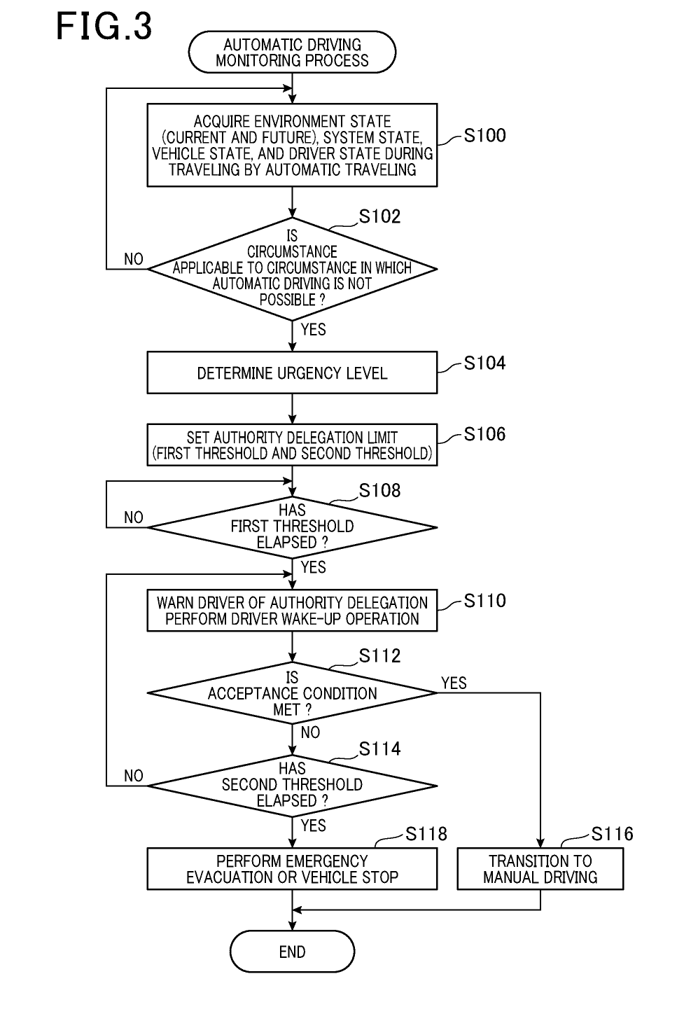

Steps in an automatic driving monitoring process performed by the traveling control unit 10 will be described with reference to a flowchart in FIG. 3. The process is performed in parallel when a control process for automatic driving is performed by the traveling control unit 10.

At step S100, the traveling control unit 10 acquires various types of information related to an environment state, a system state, a vehicle state, and a driver state in accompaniment with traveling control for automatic driving. Specifically, as information related to an environment state in the current vicinity of the own vehicle, the traveling control unit 10 acquires the peripheral conditions including other traffic, such as peripheral vehicles, traffic lights, signs, the road shape, and obstacles, based on the information acquired from the cameras 11, the radars 12, the inter-vehicle communication unit 13, and the road-vehicle communication unit 14. In addition, as information related to a future environment state, the traveling control unit 10 acquires a circumstance that the own vehicle is predicted to subsequently encounter on the route that is planned to be traveled, based on the information acquired from the inter-vehicle communication unit 13 and the road-vehicle communication unit 14.

In addition, as the information related to the system state, the traveling control unit 10 acquires information indicating a state of a vehicle system, that is, a recognition and determination system or a traveling control system that is inputted from the vehicle state input unit 16. For example, the state of a vehicle system herein includes information indicating whether or not an abnormality is present. Furthermore, as the information related to the vehicle state, the traveling control unit 19 acquires information indicating the position and behavior of the own vehicle, and operating information regarding steering wheel operation, accelerator operation, or brake operation by the driver that are inputted from the vehicle state input unit 16. Moreover, as the information related to the driver state, the traveling control unit 10 acquires information indicating the movement of eye gaze, the state of wakefulness, the posture, the operating state of switches, and the like, of the driver based on the information inputted from the driver status monitor 19.

At step S102, the traveling control unit 10 determines whether or not the circumstance determined from the various pieces of information acquired at step S100 are applicable to a circumstance in which continuation of automatic driving is not possible. Specifically, the traveling control unit 10 determines that the circumstance is such that continuation of automatic driving is not possible when, regarding the current circumstance in the periphery of the own vehicle and the circumstance predicted to be encountered in the future, an abnormality that makes continuation of automatic driving not possible is determined. For example, as circumstances in which continuation of automatic driving is not possible, road construction and accidents, temporary traffic restrictions, traffic jams, bad weather, and the approach of an emergency vehicle are given. In addition, when an abnormality is present in the vehicle system, that is, the recognition and determination system or the traveling control system, the traveling control unit 10 determines that the circumstance is such that continuation of automatic driving is not possible. When the circumstance is not applicable to a circumstance in which continuation of automatic driving is not possible (NO at step S102), the traveling control unit 10 returns to step S100. Meanwhile, when the circumstance is applicable to a circumstance in which continuation of automatic driving is not possible (YES at step S102), the traveling control unit 10 proceeds to step S104.

At step S104, the traveling control unit 10 determines the urgency level regarding the circumstance determined at step S102. Specifically, the traveling control unit 10 references the table in the urgency level database 18 (see FIG. 2) and determines the urgency level corresponding to the circumstance to which applicability has been determined at step S102. At step S106, the traveling control unit 10 sets the first threshold and the second threshold of the authority transfer limit based on the urgency level determined at step S104. Specifically, the traveling control unit 10 sets the first threshold and the second threshold of the authority transfer limit to be closer to the current point in time or the current location as the urgency level increases. Alternatively, the table in the urgency level database 18 (see FIG. 2) is referenced and, at step S102, the first threshold and the second threshold of the authority transfer limit that correspond to the circumstance to which applicability has been determined, and the urgency level are set.

In addition, when there are a plurality of circumstances in which continuation of automatic driving is not possible, the traveling control unit 10 setting the authority transfer limit based on the circumstance that has the highest urgency level can be considered. In addition, the state of the driver and the state of the vehicle, in addition to the urgency level, being reflected in the setting of the authority transfer limit can also be considered. For example, when the state of the driver or the state of the vehicle system corresponds to a specific condition that is disadvantageous in terms of cancellation of automatic driving and switching to manual driving, the traveling control unit 10 adjusts the first threshold or the second threshold of the authority transfer limit to be closer to the current point in time or the current location. As a result, response to a circumstance in which continuation of automatic driving is not possible can be made earlier.

Alternatively, an evacuation-possible location to which the own vehicle can be safely evacuated before encountering the circumstance determined at step S102 may be retrieved. The first threshold and the second threshold of the authority transfer limit may be set based on an amount of time or distance required until the discovered evacuation-possible location is reached. For example, the first threshold and the second threshold of the authority transfer limit are set to precede a timing at which the own vehicle is predicted to arrive at the evacuation-possible location. The traveling control unit 10 retrieves the evacuation-possible location based on the road shape described in the map data or information acquired through inter-vehicle communication and road-vehicle communication.

At step S108, the traveling control unit 10 determines whether or not the first threshold (time or distance) has elapsed, regarding traveling of the own vehicle after the setting of the authority transfer limit. When the first threshold has not elapsed (NO at step S108), the traveling control unit 10 repeats step S108. Then, when the first threshold has elapsed (YES at step S108), the traveling control unit 10 proceeds to step S110.

At step S110, the traveling control unit 10 gives a notification that warns that automatic driving will be cancelled and switched to manual driving, based on the content of the authority transfer limit. In addition, the traveling control unit 10 performs a wake-up operation based on the degree of wakefulness of the driver. Specifically, the traveling control unit 10 notifies the driver, through display or audio output by the notifying unit 28, of a message that indicates that cancellation of automatic driving and transition to manual driving is required to be performed by a certain time, based on the content of the authority transfer limit. For example, notification of a message such as “Prepare for cancellation of automatic driving and switching to manual driving within “∘” (one white circle that is sign or symbol for a certain distance in this example) km” or a message such as “Cancel automatic driving and switch to manual driving within 10 seconds” can be considered.

In addition, the traveling control unit 10 may retrieve an evacuation-possible location to which the own vehicle can be safely evacuated before encountering the circumstance determined at step S102, and notify the driver of information related to the evacuation-possible location. For example, when the evacuation-possible location has been identified, notification of a message such as “An evacuation-possible location has been found. The vehicle will automatically proceed to the evacuation-possible location if automatic driving is not cancelled by “∘∘” (two white circles that are signs or symbols for a certain time in this example)” can be considered. In addition, when an evacuation-possible location cannot be identified, for example, notification of a message such as “There are no evacuation-possible locations. The vehicle will automatically stop if automatic driving is not cancelled by “∘∘” (two white circles that are signs or symbols for a certain time in this example)” can be considered.

Furthermore, when the traveling control unit 10 determines a state in which the degree of wakefulness of the driver has decreased (such as drowsiness or dozing), for example, the traveling control unit 10 awakens the driver by vibrating the steering wheel or the driver's seat. Should the driver not awaken even then, the traveling control unit 10 performs shaking by operating the brake for an instant, once or a plurality of times.

At step S112, the traveling control unit 10 determines whether or not an acceptance condition regarding the driver for transition to manual driving is met. Specifically, the traveling control unit 10 determines that the acceptance condition is met under a condition that the driver has inputted an override operation, such as a steering wheel operation, an accelerator operation, a brake operation, or the like, for a driving operation based on automatic driving control. Alternatively, the traveling control unit 10 determines that the acceptance condition is met under a condition that a cancellation command for automatic driving is received from the driver. When the acceptance condition for transition to manual driving is not met (NO at step S112), the traveling control unit 10 proceeds to step S114.

At step S114, the traveling control unit 10 determines whether or not the second threshold (time or distance) regarding traveling of the own vehicle after the setting of the authority transfer limit has elapsed. When the second threshold has not elapsed (NO at step S114), the traveling control unit 10 returns to step S110. When determined that the acceptance condition for transition to manual driving is met at step S112 (YES at step S112), the traveling control unit 10 proceeds to step S116. At step S116, the traveling control unit 10 transfers authority over driving to the driver by canceling automatic driving and switching to manual driving. After step 5116, the traveling control unit 10 ends the present process.

Meanwhile, when determined that the second threshold has elapsed at step 5114 (YES at step S114), the traveling control unit 10 proceeds to step S118. At step S118, when the evacuation-possible location has been identified, the traveling control unit 10 performs emergency evacuation traveling to automatically advance the own vehicle to the evacuation-possible location. Alternatively, when the evacuation-possible location has not been identified, the traveling control unit 10 performs vehicle stop to stop the own vehicle. When making the own vehicle perform an emergency stop, the traveling control unit 10 notifies vehicles in the periphery that the own vehicle will stop by operating a display apparatus (not shown) that presents information to the periphery of the own vehicle or hazard lights. After step S118, the traveling control unit 10 ends the present process.

### [Other Modifications]

Other modifications that are applicable to the present embodiment will be described. Regarding the first threshold and the second threshold of the authority transfer limit, the driver may be allowed to adjust the values in relation to reference values set in advance, through a user interface. For example, as a result of the first threshold being changed, the driver can arbitrarily advance or delay the timing at which the warning for cancellation of automatic driving is given. In addition, as a result of the second threshold being changed, the driver can arbitrarily advance or delay the timing at which emergency evacuation or vehicle stop is performed.

When the warning for cancellation of automatic driving is given at step S110 in FIG. 3, the driver may be alerted through control of the pedal drive unit 23, the steering wheel drive unit 24, the seat drive unit 25, the air-conditioning control unit 27, or the audio and video control unit 27, in addition to display or audio output. For example, issuing an alert by an operation such as vibrating the steering wheel or the driver's seat, shaking by a brake operation, operating the air-conditioner, or turning off video and audio output can be considered. In addition, issuing an alert by an operation such as operating windshield wipers or power windows, or flashing interior light is also possible. Furthermore, a configuration in which the traveling control unit 10 transmits information to a portable communication terminal, such as a mobile phone, that is present inside the vehicle cabin by short-range wireless communication and the driver is notified of the information by the portable communication terminal is also possible. As a result of using such means of information presentation singly or in combination of a plurality thereof, it is thought that the traveling control unit 10 can issue an alert while changing the intensity of information presentation based on the state of the driver (such as the posture, the eye-gaze direction, and the degree of wakefulness).

In addition, when determined that the circumstance is applicable to a circumstance in which continuation of automatic driving is not possible, the traveling control unit 10 may identify that the driver is performing an operation other than a driving operation, and perform control to inhibit the identified operation. For example, when the traveling control unit 10 identifies that the driver is operating an audio player, outputting an audio message that warns of the cancellation of automatic driving at a louder sound volume upon lowering the reproduction sound volume of the audio can be considered. In addition, when the traveling control unit 10 identifies that the driver is focused on a display on which video content, such as television, is displayed, turning off the video or switching the video to another video of which the content is a warning for cancellation of automatic driving can be considered.

A configuration in which control to automatically decelerate the own vehicle is performed during a period from when the circumstance is determined to be applicable to a circumstance in which continuation of automatic driving is not possible until when the transition to manual driving is made at step S116 is also possible. As a result, leeway in terms of time for transition to manual driving can be provided before the circumstance in which continuation of automatic driving becomes not possible is encountered.

### [Effects]

In the vehicle traveling control system 1 according to the embodiment, the following effects are achieved.

Whether or not continuation of automatic driving is possible can be determined in advance based not only on the current circumstance in the vicinity of the own vehicle, but also on a future circumstance that is predicted to be subsequently encountered. In addition, based on the urgency of the circumstance in which continuation of automatic driving is determined to not be possible, the authority transfer limit at which to cancel automatic driving and switch to manual driving can be set, and the driver can be notified of the circumstance. As a result, the driver can be notified at an earlier stage than the point in time at which the circumstance in which continuation of automatic driving is not possible is encountered. The driver can make a response, such as canceling automatic driving and switching to manual driving, with leeway.

In addition, as the authority transfer limit, the first threshold that serves as a trigger for the notification of the warning for cancellation of automatic driving and the second threshold that serves as a trigger for emergency evacuation can be set. As a result, response can be made in stages before the circumstance in which continuation of automatic driving is not possible is encountered.

In addition, when the driver is warned of the cancellation of automatic driving, the notification mode can be changed based on whether or not an evacuation-possible location is present, or the state of the driver. As a result, effective provision of information that is suitable for various circumstances can be performed, and the driver can be prompted to make an appropriate response.

According to the above-described embodiment, in the traveling control unit 10 of the vehicle traveling control system 1 that is the driving assistance control apparatus, the functions of the driving assistance control apparatus are actualized by a program being stored in the ROM that corresponds to a non-transitory tangible recording medium, and the CPU that corresponds to a processor of a computer running the program. However, a configuration in which the program is stored in a non-transitory tangible recording medium other than the ROM (such as a non-volatile memory other than the ROM) and a processor such as the CPU runs the program is also possible. In this case, a configuration in which, as a result of the processor running the program stored in the non-transitory tangible recording medium, a method (such as a driving assistance control method) corresponding to the program is performed in the traveling control unit 10 of the vehicle traveling control system 1 is also possible.

In addition, some or all of the functions provided by the vehicle traveling control system 1 that is the driving assistance control apparatus may be configured as hardware by a single or a plurality of integrated circuits (that is, ICs), or the like. Furthermore, each unit (such as the traveling control unit 10 that corresponds to the control unit, the acquiring unit, the determining unit, the urgency level setting unit, the limit setting unit, the notifying unit, and the emergency measure unit of the driving assistance control apparatus) of the vehicle traveling control system 1 may be provided by software recorded in a non-transitory tangible recording medium, such as a non-volatile memory, and a computer that runs the software, by the software alone, by hardware alone, or by a combination thereof.

While the present disclosure has been described with reference to an embodiment thereof, it is to be understood that the disclosure is not limited to the embodiment and constructions. The present disclosure is intended to cover various modification examples and modifications within the range of equivalency. In addition, various combinations and configurations, and further, other combinations and configurations including more, less, or only a single element thereof are also within the spirit and scope of the present disclosure.

1. A driving assistance control apparatus comprising:
a control unit that performs driving assistance in which a portion or all of driving operations related to traveling of an own vehicle is automatically performed;
an acquiring unit that acquires future circumstance information related to a future circumstance that the own vehicle is predicted to subsequently encounter on a route further ahead of a current location;
a determining unit that determines whether or not the future circumstance indicated by the future circumstance information acquired by the acquiring unit is applicable to an event in which continuation of driving assistance is not possible;
an urgency level setting unit that sets an urgency level that indicates a level of urgency of the future circumstance when the determining unit determines that continuation of driving assistance will not be possible;
a limit setting unit that sets a limit related to time or distance at which to cancel driving assistance and switch to manual driving, based on the urgency level set by the urgency level setting unit;
a notifying unit that notifies a driver of information prompting cancellation of driving assistance based on content of the limit set by the limit setting unit; and
an emergency measure unit that performs an emergency measure to evacuate the own vehicle to an identified evacuation-possible location or to stop the own vehicle, when traveling of the own vehicle exceeds the limit set by the limit setting unit in a state in which cancellation of driving assistance by the driver is not performed, after the notifying unit has given notification, wherein:
the limit setting unit sets, as the limit related to time or distance, a first threshold related to distance or time and a second threshold related to distance or time, the first threshold serving as a trigger for the notification by the notifying unit to be performed and the second threshold serving as a trigger for the emergency measure by the emergency measure unit to be performed;
the notifying unit notifies the driver of the information prompting cancellation of driving assistance when traveling of the own vehicle exceeds the first threshold in a state in which driving assistance is continued, after the determining unit determines that continuation of driving assistance is not possible; and
the emergency measure unit performs the emergency measure when traveling of the own vehicle exceeds the second threshold in a state in which the driver has not canceled driving assistance after the notifying unit has given the notification.

2. (canceled)

3. (canceled)

4. The driving assistance control apparatus according to claim 1, wherein
the emergency measure unit performs control to stop the own vehicle while providing information which indicates that the own vehicle will stop, using an information presenting unit that presents information to a periphery of the own vehicle, when no evacuation-possible location can be identified.

5. The driving assistance control apparatus according to claim 4, wherein
the notifying unit changes a mode for providing the notification of information prompting cancellation of driving assistance based on whether or not the evacuation-possible location is present.

6. The driving assistance control apparatus according to claim 5, wherein
the evacuation-possible location is identified based on at least either of map information and information acquired through communication with an external apparatus, when the determining unit determines that continuation of driving assistance is not possible.

7. The driving assistance control apparatus according to claim 6, wherein
the limit setting unit is configured to allow the driver to adjust the content of the limit that is set.

8. The driving assistance control apparatus according to claim 7, wherein
the limit setting unit adjusts the content of the limit taking into consideration information acquired by a state acquiring unit that acquires a state of the own vehicle, a state of a peripheral environment, and a state of the driver.

9. The driving assistance control apparatus according to claim 8, wherein:
the notifying unit changes the mode for giving the notification of information prompting cancellation of driving assistance based on the state of the driver.

10. The driving assistance control apparatus according to claim 9, wherein:
the notifying unit performs, when the driver is identified as performing another operation that is not applicable to a driving operation, control to inhibit the operation that is not applicable to a driving operation, together with the notification of information prompting cancellation of driving assistance.

11. The driving assistance control apparatus according to claim 10, wherein:
the control unit performs control to make the own vehicle travel with deceleration, when the determining unit determines that continuation of driving assistance is not possible.

12. The driving assistance control apparatus according to claim 1, wherein
the notifying unit changes a mode for providing the notification of information prompting cancellation of driving assistance based on whether or not the evacuation-possible location is present.

13. The driving assistance control apparatus according to claim 1, wherein
the evacuation-possible location is identified based on at least either of map information and information acquired through communication with an external apparatus, when the determining unit determines that continuation of driving assistance is not possible.

14. The driving assistance control apparatus according to claim 1, wherein
the limit setting unit is configured to allow the driver to adjust the content of the limit that is set.

15. The driving assistance control apparatus according to claim 1, wherein
the limit setting unit adjusts the content of the limit taking into consideration information acquired by a state acquiring unit that acquires a state of the own vehicle, a state of a peripheral environment, and a state of the driver.

16. The driving assistance control apparatus according to claim 1, wherein:
the notifying unit changes the mode for giving the notification of information prompting cancellation of driving assistance based on the state of the driver.

17. The driving assistance control apparatus according to claim 1, wherein:
the notifying unit performs, when the driver is identified as performing another operation that is not applicable to a driving operation, control to inhibit the operation that is not applicable to a driving operation, together with the notification of information prompting cancellation of driving assistance.

18. The driving assistance control apparatus according to claim 1, wherein:
the control unit performs control to make the own vehicle travel with deceleration, when the determining unit determines that continuation of driving assistance is not possible.
